(19) United States
(12) Patent Application Publication
(10) Pub. No.: US 2025/0164670 A1
(43) Pub. Date: May 22, 2025

(54) ANTI-SPARKLE SUBSTRATES AND METHODS OF MAKING THE SAME

(71) Applicant: CORNING INCORPORATED, CORNING, NY (US)

(72) Inventors: Christine Cecala, Corning, NY (US); Ronghua Chen, Fuzhou City (CN); Melanie Lian Geiger, Horseheads, NY (US); Yuhui Jin, Painted Post, NY (US); Qiao Li, Horseheads, NY (US); Meng Shang, Painted Post, NY (US)

(21) Appl. No.: 18/947,687

(22) Filed: Nov. 14, 2024

(30) Foreign Application Priority Data
Nov. 21, 2023 (CN) 202311568566.X

(51) Int. Cl. G02B 5/02

(52) U.S. Cl. CPC G02B 5/0242

(57) ABSTRACT

Anti-sparkle substrates include a first major surface with a textured surface having a surface roughness Ra from 0.03 micrometers to 0.09 micrometers. The anti-sparkle substrate is a glass-based substrate or a ceramic-based substrate. The anti-sparkle substrate can exhibit a haze from 3% to 40% and a sparkle from 1% to 3.8%. Methods include chemically strengthening an existing first major surface, abrading the existing first major surface to form an intermediate first major surface, and etching the intermediate first major surface to form the first major surface of the anti-sparkle substrate.

This application claims the benefit of priority of Chinese Patent Application Serial No. 202311568566.X filed on Nov. 21, 2023, the content of which is relied upon and incorporated herein by reference in its entirety.

### FIELD

The present disclosure relates generally to anti-sparkle substrates and methods of making the same and, more particularly, anti-sparkle substrates and methods of making the same by abrading a surface.

### BACKGROUND

Glass-based substrates are commonly used, for example, in display devices, for example, liquid crystal displays (LCDs), electrophoretic displays (EPD), organic light-emitting diode displays (OLEDs), plasma display panels (PDPs), laser phosphor displays (LPDs), or the like. It is known to provide an anti-glare surface on glass substrates. However, an interaction between the anti-glare surface and a pixelated display can lead to sparkle, which is an undesirable grainy appearance and/or variations in the appearance of an image produced by the display device, for example, at a pixel-level size scale. Consequently, there is a desire to develop display devices that can mitigate sparkle.

### SUMMARY

The above observations can be combined to provide an anti-sparkle substrate and display devices including anti-sparkle substrates that can reduce a sparkle thereof by providing a textured surface as part of a first major surface of the anti-sparkle substrate. Reducing a sparkle through the anti-sparkle substrate of the present disclosure can increase a uniformity of light emitted from the display device, as perceived by a viewer of a display device, and/or increase an aesthetic appeal of the resulting display device by reducing the perceived graininess associated with sparkle. As demonstrated by the Examples, methods of present disclosure can provide an anti-sparkle substrate exhibiting a sparkle of 3.8% or less or 3.1% or less, which is not achieved by the Comparative Examples. As demonstrated by the Examples, methods of present disclosure can provide an anti-sparkle substrate exhibiting a gloss of 50% or more, and/or a distinctness of image (DOI) of 91% or more (e.g., 93% or more), which is not achieved by the Comparative Examples.

Without wishing to be bound by theory, it is believed that the characteristics of the textured surface of the first major surface (e.g., surface roughness Ra, height Rq, width Rsm, gradient Sdq) generated by the methods of present disclosure enable the above-reciting combinations of optical properties to be achieved simultaneously. While a select set of combinations of ranges for optical properties of the anti-sparkle substrate are set forth in this paragraph, it is to be understood that other combinations of ranges of these optical properties and/or combinations involving other optical properties reciting in the present disclosure are also possible in other aspects. Providing the anti-sparkle substrate as a glass-based substrate and/or ceramic-based substrate can increase a damage resistance of the display device.

The textured surface of the anti-sparkle substrate can be formed by abrading and then etching a first major surface that has already been chemically strengthened. As discussed herein for methods of making the anti-sparkle substrate (e.g., textured surface), the present disclosure can provide smaller peaks and/or valleys that would otherwise be obtainable by abrading the first major surface, and the smaller peaks and/or valleys enable a lower sparkle and other optical properties recited herein. While a smaller median particle size of the particle can produce smaller pits (e.g., width of the pits and/or depth of the pits), there is a physical and commercial limit to how small (and how uniform such) particles can be manufactured. In the absence of a chemically strengthened substrate, abrading followed by etching produces textured substrates with high sparkle (e.g., 4% or more) and/or high haze (e.g., 40% or more), which is undesirable for use with high-resolution display devices. As indicated by the Examples here, chemically strengthening the substrate before abrading the substrate unexpectedly produces smaller pits, which can be etched to produce anti-sparkle substrates in accordance with aspects of the present disclosure with low sparkle and/or the other optical properties recited herein.

Some example aspects of the disclosure are described below with the understanding that any of the features of the various aspects may be used alone or in combination with one another.

Aspect 1. A method of forming an anti-sparkle substrate:
chemically strengthening an existing first major surface;
abrading the existing first major surface to form an intermediate first major surface; and
etching the intermediate first major surface to form a first major surface of the anti-sparkle substrate,
wherein the anti-sparkle substrate exhibits a haze from 3% to 40% and a sparkle from 1% to 3.8%.

Aspect 2. The method of aspect 1, wherein the chemically strengthening comprises exposing the existing first major surface to a molten salt solution maintained a first temperature from 370° C. to 500° C. for a first period of time from 5 minutes to 8 hours, and the chemically strengthening forms an intermediate compressive stress region extending from the existing first major surface with an intermediate maximum compressive stress from 25 MegaPascals to 1500 MegaPascals.

Aspect 3. The method of aspect 2, wherein the anti-sparkle substrate comprises a compressive stress region extending from the first major surface comprising a maximum compressive stress from 25 MegaPascals to 1200 MegaPascals, and the maximum compressive stress is less than the intermediate maximum compressive stress.

Aspect 4. The method of any one of aspects 1-2, wherein the first major surface of the anti-sparkle substrate is substantially unstrengthened.

Aspect 5. The method of any one of aspects 1-4, wherein the abrading comprises impinging the existing first major surface with particles comprising a median particle size of 3 micrometers to 15 micrometers.

Aspect 6. The method of aspect 5, wherein the particles are propelled with a pressure from 200 kiloPascals to 550 kiloPascals.

Aspect 7. The method of any one of aspects 5-6, wherein the particles are propelled from a slurry comprising from 10 wt % to 30 wt % of the particles based on 100 wt % of the slurry.

Aspect 8. The method of any one of aspects 5-7, wherein the particles comprise SiC, Al₂O₃, or combinations thereof.

Aspect 9. The method of any one of aspects 5-8, wherein the etching removes a thickness of from 5 micrometers to 100 micrometers from the intermediate first major surface.

Aspect 10. The method of aspect 9, wherein the etching removes the thickness of from 9 micrometers to 40 micrometers from the intermediate first major surface.

Aspect 11. The method of any one of aspects 1-10, wherein the etching comprises contacting the intermediate first major surface with an acidic solution maintained at a temperature from 20° C. to 45° C. for from 2 minutes to 2 hours.

Aspect 12. The method of aspect 11, wherein the acidic solution comprises from 1 wt % to 20 wt % hydrofluoric acid based on 100 wt % of the acidic solution.

Aspect 13. The method of any one of aspects 1-10, wherein the etching comprises contacting the intermediate first major surface with an alkaline solution maintained at a temperature from 95° C. to 165° C. for from 10 minutes to 4 hours.

Aspect 14. The method of aspect 13, wherein the alkaline solution comprises from 10 wt % to 70 wt % of a hydroxide-containing compound based on 100 wt % of the alkaline solution.

Aspect 15. The method of any one of aspects 1-14, wherein the sparkle is from 3.1% to 3.8%, and the anti-sparkle substrate exhibits a distinctness of image DOI of 98% or less.

Aspect 16. The method of any one of aspects 1-14, wherein the sparkle is from 1% to 3.1%, and the anti-sparkle substrate exhibits a distinctness of image DOI of 91% or more.

Aspect 17. The method of any one of aspects 1-14, wherein the sparkle is from 1.5% to 3.1%.

Aspect 18. The method of any one of aspects 1-17, wherein the haze is from 8% to 20%.

Aspect 19. The method of any one of aspects 1-18, wherein the anti-sparkle substrate exhibits a transmittance of 92% or more and a gloss from 55% to 150%.

Aspect 20. The method of any one of aspects 1-19, wherein a surface roughness Ra of the first major surface is from 0.03 micrometers to 0.09 micrometers.

Aspect 21. The method of any one of aspects 1-20, wherein a root mean square height Sq of the first major surface is from 0.05 micrometers to 0.17 micrometers.

Aspect 22. An anti-sparkle substrate comprising:
a first major surface comprising a textured surface, a surface roughness Ra of the first major surface is from 0.03 micrometers to 0.09 micrometers,
wherein the anti-sparkle substrate is a glass-based substrate or a ceramic-based substrate, and the anti-sparkle substrate exhibits a haze from 3% to 40% and a sparkle from 1% to 3.8%.

Aspect 23. The anti-sparkle substrate of aspect 22, wherein the anti-sparkle substrate comprises a compressive stress region extending from the first major surface comprising a maximum compressive stress from 25 MegaPascals to 1200 MegaPascals.

Aspect 24. The anti-sparkle substrate of aspect 22, wherein the first major surface of the anti-sparkle substrate is substantially unstrengthened.

Aspect 25. The anti-sparkle substrate of any one of aspects 22-24, wherein the sparkle is from 3.1% to 3.8%, and the anti-sparkle substrate exhibits a distinctness of image DOI of 98% or less.

Aspect 26. The anti-sparkle substrate of any one of aspects 22-24, wherein the sparkle is from 1% to 3.1%, and the anti-sparkle substrate exhibits a distinctness of image DOI of 91% or more.

Aspect 27. The anti-sparkle substrate of any one of aspects 22-24, wherein the sparkle is from 1.5% to 3.1%.

Aspect 28. The anti-sparkle substrate of any one of aspects 22-27, wherein the haze is from 8% to 20%.

Aspect 29. The anti-sparkle substrate of any one of aspects 22-28, wherein the anti-sparkle substrate exhibits a transmittance of 92% or more and a gloss from 55% to 150%.

Aspect 30. The anti-sparkle substrate of any one of aspects 22-29, wherein a root mean square height Sq of the first major surface is from 0.05 micrometers to 0.17 micrometers.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic view of an example anti-sparkle substrate in accordance with aspects;

FIG. 2 is an enlarged view 2 of FIG. 1 showing a textured surface of the anti-sparkle substrate in accordance with aspects;

FIG. 3 is a schematic plan view of an example consumer electronic device according to aspects;

FIG. 4 is a schematic perspective view of the example consumer electronic device of FIG. 3;

FIG. 5 is a flow chart illustrating example methods of making an anti-sparkle substrate in accordance with aspects;

FIGS. 6-9 schematically illustrate steps in method of making an anti-sparkle substrate in accordance with aspects of the disclosure;

FIG. 10 schematically illustrates haze on the vertical axis (y-axis) as a function of thickness removed by etching on the horizontal axis (x-axis);

FIG. 11 schematically illustrates sparkle on the vertical axis (y-axis) as a function of haze on the horizontal axis (x-axis); and

FIG. 12 schematically illustrates distinctness of image DOI on the vertical axis (y-axis) as a function of haze on the horizontal axis (x-axis).

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, claims may encompass many different aspects of various aspects and should not be construed as limited to the aspects set forth herein.

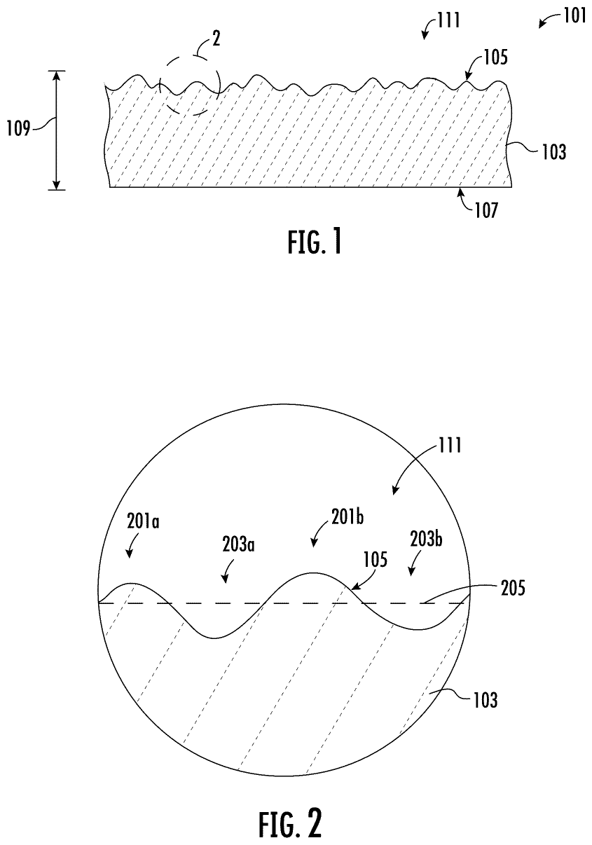

FIGS. 1-2 illustrate schematic views of an anti-sparkle substrate 101 including a first major surface 105 that is a textured surface 111 in accordance with aspects of the disclosure. Unless otherwise noted, a discussion of features of aspects of one display device, anti-sparkle substrate, and/or feature of the plurality of features can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIGS. 1-2, the anti-sparkle substrate 101 comprises a substrate 103. In aspects, the substrate can comprise a glass-based material and/or a ceramic-based material.

As used herein, “glass-based” material includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion-exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. “Glass-ceramics” include materials produced through controlled crystallization of glass. In aspects, glass-ceramics have about 1% to about 99% crystallinity. Exemplary aspects of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes, for example, an MAS-system glass-ceramic material may be strengthened in Li₂SO₄ molten salt. Exemplary aspects of glass materials (e.g., used below in the Examples) are described in U.S. Pat. No. 8,586,492 (issued Nov. 19, 2013), U.S. Pat. No. 8,951,927 (issued Feb. 10, 2015), U.S. Pat. No. 8,969,226 (issued Mar. 3, 2015), U.S. Pat. No. 9,593,042 (issued Mar. 14, 2017), and U.S. Pat. No. 11,066,323 (issued Jul. 20, 2021) the contents of which are incorporated by reference herein.

As used herein, “ceramic-based” includes both ceramics and glass-ceramics, wherein glass-ceramics have one or more crystalline phases and an amorphous, residual glass phase. Ceramic-based materials can be strengthened (e.g., chemically strengthened). In aspects, a ceramic-based material can be formed by heating a glass-based material to form ceramic (e.g., crystalline) portions. In further aspects, ceramic-based materials can comprise one or more nucleating agents that can facilitate the formation of crystalline phase(s). In aspects, ceramic-based materials can comprise one or more oxides, nitrides, oxynitrides, carbides, borides, and/or silicides. Example aspects of ceramic oxides include zirconia (ZrO₂), zircon (ZrSiO₄), an alkali-metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxides, beryllium oxides, vanadium oxide (VO₂), fused quartz, mullite (a mineral comprising a combination of aluminum oxide and silicon dioxide), and spinel (MgAl₂O₄). Example aspects of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example aspects of oxynitride ceramics include silicon oxynitride, aluminum oxynitride, and a silicon-aluminum oxynitride.

In aspects, the substrate 103 can comprise a pencil hardness of 8H or more, for example, 9H or more. As used herein, pencil hardness is measured in accordance with ASTM D 3363-20 using standard lead graded pencils. Throughout the disclosure, an elastic modulus (e.g., Young's modulus) and/or a Poisson's ratio is measured using ISO 527-1:2019. In aspects, the substrate 103 can comprise an elastic modulus of about 10 GigaPascal (GPa) or more, about 30 GPa or more, about 50 GPa or more, about 60 GPa or more, about 70 GPa or more, about 200 GPa or less, about 150 GPa or less, about 120 GPa or less, 100 GPa or less, about 90 GPa or less, or about 80 GPa or less. In aspects, the substrate 103 can comprise an elastic modulus in a range from about 10 GPa to about 200 GPa, from about 30 GPa to about 150 GPa, from about 50 GPa to about 120 GPa, from about 60 GPa to about 100 GPa, from about 60 GPa to about 90 GPa, from about 70 GPa to about 90 GPa, or any range or subrange therebetween.

As shown in FIGS. 1-2, the substrate 103 of the anti-sparkle substrate 102 or 202 can comprise a first major surface 105 and a second major surface 107 opposite the first major surface 105. In aspects, as shown in FIG. 1, the second major surface 107 can comprise a flat surface and/or a planar surface, although it is to be understood that the second major surface can be curved or textured in other aspects. As shown in FIGS. 1-2, a substrate thickness 109 is measured as an average distance between the first major surface 105 and the second major surface 107 averaged over the first major surface 105. In aspects, the substrate thickness 109 be about 25 micrometers (μm) or more, about 80 μm or more, about 100 μm or more, about 125 μm or more, about 150 μm or more, about 200 μm or more, about 500 μm or more, about 700 μm or more, about 5 millimeters (mm) or less, about 3 mm or less, about 2 mm or less, about 1 mm or less, about 800 μm or less, about 500 μm or less, about 300 μm or less, about 200 μm or less, about 180 μm or less, or about 160 μm or less. In aspects, the substrate thickness 109 can be less in a range from about 25 μm to about 5 mm, from about 25 μm to about 3 mm, from about 25 μm to about 2 mm, from about 80 μm to about 1 mm, from about 80 μm to about 800 μm, from about 100 μm to about 500 μm, from about 100 μm to about 300 μm, from about 125 μm to about 200 μm, from about 150 μm to about 160 μm, or any range or subrange therebetween. In aspects, the substrate thickness 109 can be about 500 μm or more, for example, from about 500 μm to about 3 mm, from about 700 μm to about 2 mm, from about 700 μm to about 1 mm, or any range or subrange therebetween. In aspects, the substrate thickness 109 can be about 500 μm or less, for example, from about 25 μm to about 500 μm, from about 25 μm to about 300 μm, from about 80 μm to about 200 μm, from about 100 μm to about 200 μm, or any range or subrange therebetween.

As schematically shown in FIG. 2, the textured surface 111 of the first major surface can comprise a plurality of peaks 201a and 201b and a plurality of valleys 203a and 203b. While only a few peaks and valleys are shown in FIG. 2, it is to be understood that the textured surface 111 can be unevenly or irregularly textured as opposed to uniformly textured with identical peaks and valleys. Also, it is to be understood that the textured surface can comprise the entire first major surface, although the textured surface can comprise less than the entire first major surface (e.g., the textured surface may not be present around a periphery of the first major surface and/or in areas not aligned with a display device.) in other aspects. FIG. 2 shows a midline 205 of the textured surface 111 of the first major surface 105, which corresponds to a plane (although the surface can be curved) defined by a series of locally averaged locations of the first major surface 105. Consequently, the midline 205 corresponds to the “midline” used to calculate surface roughness Ra, height Sq (described in the following paragraph). As discussed below for methods of making the anti-sparkle substrate (e.g., textured surface), the present disclosure can provide smaller peaks and/or valleys that would otherwise be obtainable by abrading the first major surface, and the smaller peaks and/or valleys enable a lower sparkle and other optical properties recited herein.

Without wishing to be bound by theory, the textured surface of the first major surface can disrupt and/or reduce the intensity of specular reflection from the textured surface that would otherwise be associated with glare. Further, the textured surface of the first major surface can be irregular to reduce an incidence of sparkle (see below). Throughout the disclosure, a surface profile of the first major surface is measured over a test area of at least 200 μm by 200 μm as measured using a New View 9000 optical profiler (Zygo Corporation), which is used to characterize the first major surface using the parameters defined in ISO 4287:1997 and ISO 25178. As used herein, surface roughness Ra is calculated as an arithmetical mean of the absolute deviation of a surface profile from an average position. In further aspects, a surface roughness Ra of the textured surface can be about 0.03 μm or more, about 0.035 μm or more, about 0.04 μm or more, about 0.045 μm or more, about 0.05 μm or more, about 0.055 μm or more, about 0.06 μm or more, about 0.07 μm or more, about 0.09 μm or less, about 0.085 μm or less, about 0.08 μm or less, about 0.07 μm or less, about 0.065 or less, or about 0.06 μm or less. In further aspects, the surface roughness Ra can be in a range from about 0.03 μm to about 0.09 μm, from about 0.035 μm to about 0.085 μm, from about 0.04 μm to about 0.08 μm, from about 0.045 μm to about 0.075 μm, from about 0.05 μm to about 0.07 μm, or any range or subrange therebetween.

As used herein, height Sq is calculated as the root mean square deviation of a surface profile from an average position. Without wishing to be bound by theory, Sq is greater than or equal to Ra. In further aspects, a height Sq of the textured surface can be about 0.05 μm or more, about 0.06 μm or more, about 0.07 μm or more, about 0.08 μm or more, about 0.09 μm or more, about 0.10 μm or more, about 0.20 μm or less, about 0.17 μm or less, 0.15 μm or less, about 0.14 μm or less, about 0.13 μm or less, about 0.12 μm or less, about 0.11 μm or less, about 0.10 μm or less, about 0.09 μm or less, about 0.08 μm or less, or about 0.07 μm or less. In further aspects, a height Sq of the textured surface can be in a range from about 0.05 μm to about 0.20 μm, from about 0.05 μm to about 0.17 μm, from about 0.05 μm to about 0.15 μm, from about 0.06 μm to about 0.14 μm, from about 0.06 μm to about 0.13 μm, from about 0.07 to about 0.12 μm, from about 0.08 μm to about 0.11 μm, from about 0.09 μm to about 0.10 μm, or any range or subrange therebetween. In aspects, the height Sq can be about 0.13 μm or less, for example, in a range from about 0.05 μm to about 0.13 μm, from about 0.06 μm to about 0.12 μm, from about 0.06 μm to about 0.11 μm, from about 0.08 μm to about 0.10 μm, or any range or subrange therebetween.

As used herein, the arithmetic mean value of widths of the features Rsm of the textured surface, where the “feature” refers to a peak and an adjacent valley (e.g., see peak 201a and valley 203a in FIG. 2). In aspects, the Rsm width can be about 5 μm or more, about 7 μm or more, about 9 μm or more, about 10 μm or more, about 11 or more, about 12 μm or more, about 13 μm or more, about 20 μm or less, about 17 μm or less, about 16 μm or less, about 15 μm or less, about 14 μm or less, about 13 μm or less, about 12 μm or less, or about 11 μm or less. In aspects, the Rsm width can be in a range from about 5 μm to about 20 μm, from about 5 μm to about 17 μm, from about 7 μm to about 16 μm, from about 9 μm to about 15 μm, from about 10 μm to about 14 μm, from about 11 μm to about 13 μm, or any range or subrange therebetween. In aspects, the Rsm width can be about 16 μm or less, for example, in a range from about 5 μm to about 16 μm, from about 7 μm to about 15 μm, from about 9 μm to about 14 μm, from about 10 μm to about 13 μm, or any range or subrange therebetween.

As used herein, a gradient Sdq is defined as a root mean square of slopes of the textured surface and is unitless (e.g., mm/mm or μm/μm). In aspects, Sdq can be about 0.005 or more, about 0.008 or more, about 0.01 or more, about 0.02 or more, about 0.03 or more, about 0.04 or more, about 0.05 or more, about 0.06 or more, about 0.08 or more, about 0.10 or more, about 0.12 or more, about 0.15 or more, about 0.27 or less, about 0.25 or less, about 0.22 or less, about 0.20 or less, about 0.18 or less, about 0.16 or less, about 0.14 or less, about 0.12 or less, about 0.10 or less, about 0.08 or less, about 0.06 or less, or about 0.04 or less. In aspects, the gradient Sdq can be in a range from about 0.005 to about 0.27, from about 0.008 to about 0.25, from about 0.01 to about 0.22, from about 0.02 to about 0.20, from about 0.03 to about 0.18, from about 0.04 to about 0.16, from about 0.05 to about 0.14, from about 0.06 to about 0.12, from about 0.07 to about 0.10, or any range or subrange therebetween. In aspects, the gradient Sdq can be about 0.16 or less, for example, in a range from about 0.01 to about 0.16, from about 0.02 to about 0.16, from about 0.03 to about 0.16, from about 0.05 to about 0.14, from about 0.06 to about 0.12, from about 0.07 to about 0.12, from about 0.08 to about 0.10, or any range or subrange therebetween.

Throughout the disclosure, a refractive index is measured in accordance with ASTM E1967-19 using light comprising an optical wavelength of 589 nm. In aspects, a substrate refractive index of the substrate 103 of the anti-sparkle substrate 102 or 202 can be about 1.4 or more, about 1.45 or more, about 1.47 or more, about 1.49 or more, about 1.5 or more, about 1.53 or more, about 1.55 or more, about 1.6 or less, about 1.58 or less, about 1.56 or less, about 1.55 or less, about 1.54 or less, about 1.53 or less, about 1.52 or less, or about 1.54 or less. In aspects, a substrate refractive index of the substrate 103 of the anti-sparkle substrate 101 can be in a range from about 1.4 to about 1.6, from about 1.45 to about 1.58, from about 1.47 to about 1.56, from about 1.49 to about 1.55, from about 1.5 to about 1.54, from about 1.51 to about 1.53, or any range or subrange therebetween.

In aspects, the substrate 103 may comprise one or compressive stress regions, for example, extending from the first major surface 105 and/or the second major surface 107. In aspects, the compressive stress region may be created by chemically strengthening the substrate. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate can enable small (e.g., smaller than about 10 mm or less) bend radii because the compressive stress from the chemical strengthening can counteract the bend-induced tensile stress on the outermost surface of the substrate. A compressive stress region may extend into a portion of the substrate for a depth called the depth of compression. As used herein, depth of compression means the depth at which the stress in the chemically strengthened substrates described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure a depth of compression. Unless specified otherwise, compressive stress (including surface CS) is measured by a surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the glass, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the substrate 103 may be chemically strengthened to form a first compressive stress region extending to a first depth of compression from the first major surface 105. In aspects, the substrate 103 may be chemically strengthened to form a second compressive stress region extending to a second depth of compression from the second major surface 107. In even further aspects, the first depth of compression (e.g., from the first major surface 105) and/or second depth of compression (e.g., from the second major surface 107) as a percentage of the substrate thickness 109 can be about 1% or more, about 5% or more, about 10% or more, about 30% or less, about 25% or less, or about 20% or less. In even further aspects, the first depth of compression and/or the second depth of compression as a percentage of the substrate thickness 109 can be in a range from about 1% to about 30%, from about 1% to about 25%, from about 5% to about 25%, from about 5% to about 20%, from about 10% to about 20%, or any range or subrange therebetween. In aspects, the first depth of compression and/or the second depth of compression can be about 1 μm or more, about 10 μm or more, about 50 μm or more, about 200 μm or less, about 150 μm or less, or about 100 μm or less. In aspects, the first depth of compression and/or the second depth of compression can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween. In aspects, the first depth of compression can be greater than, less than, or substantially the same as the second depth of compression. By providing a glass-based substrate and/or a ceramic-based substrate comprising a first depth of compression and/or a second depth of compression in a range from about 1% to about 30% of the first thickness, good impact and/or puncture resistance can be enabled.

In aspects, the substrate 103 can comprise a first depth of layer of one or more alkali metal ions associated with the first compressive stress region and/or a second depth of layer of one or more alkali metal ions associated with the second compressive stress region. In aspects, the first depth of layer and/or second depth of layer as a percentage of the substrate thickness 109 can be about 1% or more, about 5% or more, about 10% or more, about 15% or more, about 20% or more, about 35% or less, about 30% or less, about 25% or less, or about 22% or less. In aspects, the first depth of layer and/or second depth of layer as a percentage of the substrate thickness 109 can be in a range from about 1% to about 35%, from about 5% to about 35%, from about 5% to about 30%, from about 10% to about 30%, from about 10% to about 25%, from about 15% to about 25%, from about 15% to about 22%, from about 20% to about 22%, or any range or subrange therebetween. In aspects, the first depth of layer and/or second depth of layer can be about 1 μm or more, about 10 μm or more, about 50 μm or more, about 200 μm or less, about 150 μm or less, or about 100 μm or less. In aspects, the first depth of layer and/or second depth of layer of layer can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween.

In aspects, the first compressive stress region can comprise a maximum first compressive stress. In aspects, the second compressive stress region can comprise a maximum second compressive stress. In further aspects, the maximum first compressive stress and/or the maximum second compressive stress can be about 25 MegaPascals (MPa) or more, about 50 MPa or more, 100 MegaPascals or more, about 300 MPa or more, about 500 MPa or more, about 700 MPa or more, about 1,500 MPa or less, about 1,200 MPa or less, about 1,000 MPa or less, or about 900 MPa or less. In further aspects, the maximum first compressive stress and/or the maximum second compressive stress can be in a range from about 25 MPa to about 1,500 MPa, from about 25 MPa to about 1,200 MPa, from about 50 MPa to about 1,200 MPa, from about 100 MPa to about 1,200 MPa, from about 300 MPa to about 1,000 MPa, from about 300 MPa to about 1,000 MPa, from about 500 MPa to about 900 MPa, from about 700 MPa to about 900 MPa, or any range or subrange therebetween. Providing a maximum first compressive stress and/or a maximum second compressive stress in a range from about 25 MPa to about 1,500 MPa can enable good impact and/or puncture resistance. Alternatively, in aspects, the first major surface and/or the second major surface of the anti-sparkle substrate can be substantially unstrengthened and/or unstrengthened. As used herein, “substantially unstrengthened” refers to a maximum compressive stress (e.g., at the corresponding major surface) less than 25 MPa.

In aspects, the substrate 103 can comprise a central tension region positioned between the first compressive stress region and the second compressive stress region. In further aspects, the central tension region can comprise a maximum central tensile stress. In aspects, the maximum central tensile stress can be about 10 MPa or more, about 25 MPa or more, about 50 MPa or more, about 100 MPa or more, about 200 MPa or more, about 250 MPa or more, about 750 MPa or less, about 600 MPa or less, about 500 MPa or less, about 450 MPa or less, about 400 MPa or less, about 350 MPa or less, or about 300 MPa or less. In aspects, the maximum central tensile stress can be in a range from about 10 MPa to about 750 MPa, from about 25 MPa to about 600 MPa, from about 50 MPa to about 600 MPa, from about 100 MPa to about 600 MPa, from about 100 MPa to about 500 MPa, from about 200 MPa to about 500 MPa, from about 200 MPa to about 450 MPa, from about 250 MPa to about 450 MPa, from about 250 MPa to about 350 MPa, from about 250 MPa to about 300 MPa, or any range or subrange therebetween.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of the display device or the housing comprises the anti-sparkle substrate 101 discussed throughout the disclosure. The consumer electronic product can comprise a portable electronic device, for example, a smartphone, a tablet, a wearable device (e.g., watch), a navigation system, or a laptop. Also, it is to be understood that the anti-sparkle substrate 101 discussed throughout the disclosure can be incorporated into an architectural article, transportation article (e.g., automotive, train, aircraft, sea craft, etc.), or appliance articles including a display.

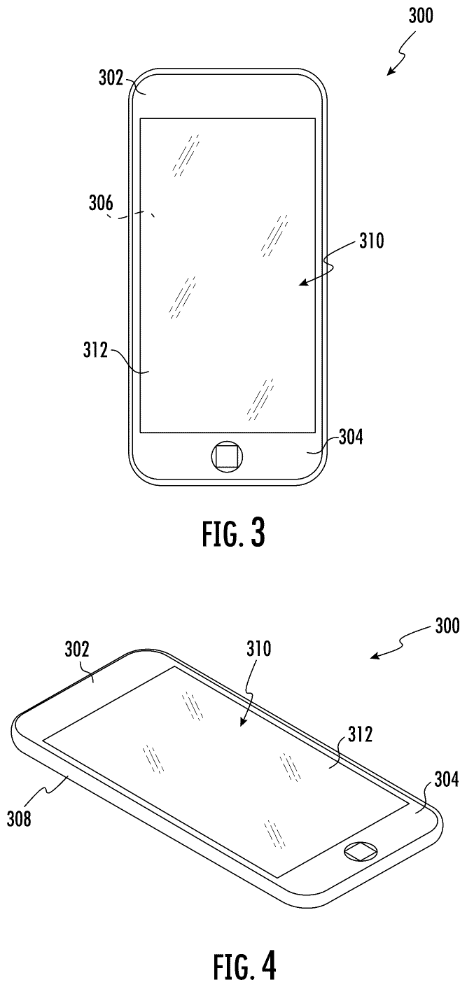

The anti-sparkle substrate disclosed herein may be incorporated into another article, for example, an article with a display (or display articles) (e.g., consumer electronics, including mobile phones, tablets, computers, televisions, monitors, and the like), architectural articles, transportation articles (e.g., automotive, trains, aircraft, sea craft, etc.), or appliance articles. An exemplary article incorporating any of the anti-sparkle substrates disclosed herein is shown in FIGS. 3-4. Specifically, FIGS. 3-4 show a consumer electronic device 300 including a housing 302 having front 304, back 306, and side surfaces 308. Although not shown, the consumer electronic device can comprise electrical components that are at least partially inside or entirely within the housing. For example, electrical components include at least a controller, a memory, and a display. As shown in FIGS. 3-4, the display 310 can be at or adjacent to the front surface of the housing 302. The consumer electronic device can comprise a cover substrate 312 at or over the front surface of the housing 302 such that it is over the display 310. In aspects, the cover substrate and/or at least a portion of the housing can comprise the anti-sparkle substrate of the present disclosure. In further aspects, the cover substrate can comprise the anti-sparkle substrate of the present disclosure.

As discussed above with reference to FIGS. 3-4, a display device (e.g., consumer electronic device 300) can comprise the anti-sparkle substrate 101 disposed over a display (of the electric components). In aspects, the display can be a pixelated display comprising at least one pixel including a plurality of sub-pixels. In aspects, a pixel of the at least one pixel can comprise three sub-pixels, for example, a red sub-pixel (e.g., configured to emit light corresponding to a wavelength in a range from about 600 nm to about 660 nm), a green sub-pixel (e.g., configured to emit light corresponding to a wavelength in a range from about 500 nm to about 560 nm), and a blue-sub-pixel (e.g., configured to emit light corresponding to a wavelength in a range from about 430 nm to about 490 nm), although other configurations are possible in other aspects. In aspects, a sub-pixel pitch defined as an on-center distance between adjacent sub-pixels in the same pixel can be about 25 μm or more, about 40 μm or more, about 50 μm or more, about 60 μm or more, about 200 μm or less, about 100 μm or less, about 80 μm or less, or about 60 μm or less. In aspects, the sub-pixel pitch can be in a range from about 25 μm to about 200 μm, from about 40 μm to about 100 μm, from about 50 μm to about 80 μm, or any range or subrange therebetween. In aspects, a pixel pitch is defined as the width of a pixel and can be about 75 μm or more, about 100 μm or more, about 150 μm, about 180 μm or more, about 200 μm or more, about 800 μm or less, about 500 μm or less, about 300 μm or less, about 250 μm or less, or about 200 μm or less. In aspects, the pixel pitch can be in a range from about 75 μm to about 800 μm, from about 100 μm to about 500 μm, from about 150 μm to about 300 μm, from about 180 μm to about 250 μm, or any range or subrange therebetween.

In aspects, the anti-sparkle substrate 101 can exhibit sparkle as measured in terms of percent. Unless otherwise specified, sparkle is measured using a SMS-1000 (Display-Messtechnik & Systeme) and a display arrangement that includes an edge-lit liquid crystal display screen (twisted nematic liquid crystal display) having a resolution of 140 pixels-per-inch (ppi) and a 1 mm thick stack of glass between the pixel layer of the display screen and the substrate to be tested. To determine sparkle of a display system or an anti-glare surface that forms a portion of a display system, a screen is placed in the focal region of an “eye-simulator” camera (of the SMS-1000), which approximates the parameters of the eye of a human observer. As such, the camera system includes an aperture (or “pupil aperture”) that is inserted into the optical path to adjust the collection angle of light, and thus approximate the aperture of the pupil of the human eye. In the sparkle measurements described herein, the iris diaphragm is set to the full angle of the device, which subtends an angle of at least 20 milliradians. A sparkle measurement is performed by (1) focusing the camera and lens assembly on the pixel layer of the display screen, (2) collecting an image of the sample on the display, (3) translating the sample, (4) collecting a second image of the textured in that new region, and (5) calculating the sparkle. The sparkle calculation involves taking the difference between the two images, applying a spatial filter, and calculating the standard deviation (or noise) in the resulting image. Filtering is used to account for the limited angular resolution of the human eye and to separate the display pixel modulation from the sparkle generated by the surface (e.g., anti-sparkle surface of the anti-sparkle substrate).

Display “sparkle” is a phenomenon that can occur when anti-glare or light-scattering surfaces are incorporated into a display system. Sparkle is associated with a very fine grainy appearance that can appear to have a shift in the pattern of the grains with changing viewing angle of the display. This type of sparkle is observed when pixelated displays such as LCDs are viewed through an antiglare surface. Such sparkle is of a different type and origin from “sparkle” or “speckle” that has been observed and characterized in projection or laser systems. In aspects, the sparkle value of the anti-sparkle substrate 101 can be about 3.8% or less, about 3.6% or less, about 3.5% or less, about 3.3% or less, about 3.2% or less, about 3.1% or less, about 3.0% or less (or about 3% or less), about 2.7% or less, about 2.5% or less, about 2.2% or less, about 2.0% or less (or about 2% or less), about 1.9% or less, about 1.8% or less, about 1.0% or more (or about 1% or more), about 1.2% or more, about 1.5% or more, about 1.6% or more, about 1.7% or more, about 1.8% or more, about 1.9% or more, about 2.0% or more (or about 2% or more), about 2.2% or more, about 2.5% or more, about 2.7% or more, or about 3.0% or more (or about 3% or more). In aspects, the sparkle value of the anti-sparkle substrate 101 can be in a range from about 1% to about 3.8%, from about 1% to about 3.6%, from about 1.2% to about 3.5%, from about 1.2% to about 3.3%, from about 1.5% to about 3.2%, from about 1.5% to about 3.1%, from about 1.6% to about 3.0%, from about 1.7% to about 2.7%, from about 1.8% to about 2.5%, from about 1.9% to about 2.2%, from about 2.0% to about 2.2%, or any range or subrange therebetween. In aspects, the sparkle value of the anti-sparkle substrate 101 can be about 3.5% or less, for example, in a range from about 1.0% to about 3.5%, from about 1.2% to about 3.3%, from about 1.5% to about 3.1%, or any range or subrange therebetween. In aspects, the sparkle value of the anti-sparkle substrate 101 can be about 3.1% or more, for example, in a range from about 3.1% to about 3.8%, from about 3.2% to about 3.8%, from about 3.3% to about 3.7%, from about 3.4% to about 3.7%, from about 3.5% to about 3.6%, or any range or subrange therebetween. In aspects, preferred ranges for the sparkle value are from about 1% to about 3.8%, from about 1.5% to about 3.1%, or from about 3.1% to about 3.8%. Reducing a sparkle through the anti-sparkle substrate of the present disclosure can increase a uniformity of light emitted from the display device, as perceived by a viewer of a display device, and/or increase an aesthetic appeal of the resulting display device by reducing the perceived graininess associated with sparkle. As demonstrated by the Examples, methods of present disclosure can provide an anti-sparkle substrate exhibiting a sparkle of 3.8% or less (e.g., 3.5% or less, or 3.1% or less), which is not achieved by the Comparative Examples.

The transmittance and haze values reported herein are measured using a BYK Haze-Gard Dual (BYK Gardner). In aspects, an “optically transparent material” or an “optically clear material” can have an average transmittance of 75% or more, 80% or more, 85% or more, or 90% or more, 92% or more, 93% or more, 94% or more, 95% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from about 400 nm to about 700 nm and averaging the measurements. In aspects, the substrate 103 can comprise an average transmittance (averaged over optical wavelengths from 400 nm to 700 nm) of about 80% or more, about 90% or more, about 91% or more, about 92.0% or more, about 92.2% or more, about 92.5% or more, about 92.8% or more, about 93.0% or more, about 99% or less, about 96% or less, about 95% or less, or about 94% or less. In aspects, the substrate can comprise an average transmittance (averaged over optical wavelengths from 400 nm to 700 nm) can be in a range from about 80% to about 99%, from about 90% to about 96%, from about 91% to about 96%, from about 92.0% to about 95%, from about 92.2% to about 94%, from about 92.5% to about 94%, from about 92.8% to about 93%, or any range or subrange therebetween.

As used herein, haze refers to transmission haze that is measured through the textured surface 111 in accordance with ASTM D1003-21 at 0° relative to a direction normal to the textured surface 111. Haze is measured using a BYK Haze-Gard Dual (BYK Gardner). A CIE D65 illuminant is used as the light source for illuminating the substrate 103. Haze values reported herein are measured through a substrate comprising a thickness of 0.7 mm with the light incident on the second major surface 107 being measured as it exits the textured surface 111 of the first major surface 105. In further aspects, the haze of the anti-sparkle substrate 101 can be about 40% or less, about 35% or less, about 32% or less, about 30% or less, about 28% or less, about 25% or less, about 22% or less, about 20% or less, about 18% or less, about 16% or less, about 14% or less, about 12% or less, about 1% or more, about 2% or more, about 3% or more, about 4% or more, about 5% or more, about 6% or more, about 7% or more, about 8% or more, about 9% or more, about 10% or more, about 11% or more, about 13% or more, about 15% or more, or about 17% or more. In further aspects, the haze of the anti-sparkle substrate 101 can be in a range from about 1% to about 40%, from about 2% to about 40%, from about 3% to about 40%, from about 3% to about 35%, from about 4% to about 32%, from about 5% to about 30%, from about 5% to about 28%, from about 6% to about 25%, from about 7% to about 22%, from about 8% to about 20%, from about 9% to about 18%, from about 10% to about 16%, from about 11% to about 14%, or any range or subrange therebetween.

As used herein, gloss is measured in accordance with ASTM D523 at an angle of incidence of 60° relative to a direction normal to the textured surface 111. Gloss measurements are calibrated using standards acquired from the BAM Federal Institute of Materials Research and Testing to produce the reported gloss values. As such, the reported gloss values reported in percentages (%) are equivalent to standard gloss units (SGU). Unless otherwise indicated, gloss was measured using a Rhopoint IQ 20/60/85 Gloss Haze DOI Meter (Rhopoint Americas Inc.). In aspects, the gloss value of the anti-sparkle substrate 101 can be about 55% or more, about 60% or more, about 65% or more, about 70% or more, about 75% or more, about 80% or more, about 90% or more, about 100% or more, about 110% or more, about 150% or less, about 140% or less, about 130% or less, about 125% or less, about 120% or less, about 115% or less, about 110% or less, about 100% or less, about 90% or less, about 80% or less, about 70% or less. In aspects, the gloss value of the anti-sparkle substrate 101 can be in a range from about 55% to about 150%, from about 60% to about 140%, from about 65% to about 130%, from about 70% to about 125%, from about 75% to about 120%, from about 80% to about 115%, from about 90% to about 110%, or any range or subrange therebetween. In aspects, the gloss value of the anti-sparkle substrate 101 can be 100% or less, for example, in a range from about 30% to about 100%, from about 50% to about 100%, from about 55% to about 90%, from about 60% to about 80%, from about 65% to about 80%, or any range or subrange therebetween. As demonstrated by the Examples, methods of present disclosure can provide an anti-sparkle substrate exhibiting a gloss of 50% or more, which is not achieved by the Comparative Examples.

As used herein, distinctness of image (DOI) is measured in accordance with ASTM D5767 method A as 100×[1−Ro/Rs], where Rs is a relative reflection intensity averaged in the specular direction (averaged between +0.05° and −0.05° from a specular reflection of the incident light) and Ro is a relative reflection intensity averaged in the specular direction over angles from 0.2° to 0.4° from the specular reflection. Unless otherwise indicated DOI is measured using Rhopoint IQ 20/6085 Gloss Haze DOI Meter (Rhopoint Americas). In aspects, the DOI of the anti-sparkle substrate 101 can be about 91% or more, about 92% or more, about 93% or more, about 94 or more, about 95% or more, about 96% or more, about 97% or more, about 99% or less, about 98% or less, about 97% or less, about 96% or less, about 95% or less, about 94% or less, about 93% or less, or about 92% or less. In aspects, the DOI of the anti-sparkle substrate 101 can be in a range from about 91% to about 99%, from about 92% to about 98%, from about 93% to about 98%, from about 93% to about 97%, from about 94% to about 97%, from about 95% to about 96%, or any range or subrange therebetween. As demonstrated by the Examples, methods of present disclosure can provide an anti-sparkle substrate exhibiting a DOI of 91% or more (e.g., 93% or less), which is not achieved by the Comparative Examples.

In aspects, the anti-sparkle substrate 101 can exhibit a sparkle from 1% to 3.8% (e.g., from 1.5% to 3.5% or from 1.5% to 3.1%) in combination with a haze of from 3% to 40% (e.g., from 3% to 20%, from 5% to 16%). In aspects, the anti-sparkle substrate 101 can exhibit a sparkle from 1% to 3.5% (e.g., from 1.5% to 3.1%) in combination with a DOI of 91% or more (e.g., from 91% to 99%, from 93% to 98%, or from about 94% to about 98%). Alternatively, in aspects, the anti-sparkle substrate 101 can exhibit a sparkle from 3.1% to 3.8% (e.g., from 3.5% to 3.8% or from 3.1% to 3.5%) in combination with a DOI of 98% or less (e.g., from 91% to 98% or from 91% to 93%). In aspects, the anti-sparkle substrate 101 can exhibit a transmittance of 92% or more in combination with a gloss from 55% to 150% (e.g., from 50% to 130%, from 55% to 120%, from 70% to 120%, or from 100% to 120%). Without wishing to be bound by theory, it is believed that the characteristics of the textured surface of the first major surface (e.g., surface roughness Ra, height Rq, width Rsm, gradient Sdq) generated by the methods of present disclosure enable the above-reciting combinations of optical properties to be achieved simultaneously. While a select set of combinations of ranges for optical properties of the anti-sparkle substrate are set forth in this paragraph, it is to be understood that other combinations of ranges of these optical properties and/or combinations involving other optical properties reciting in the present disclosure are also possible in other aspects.

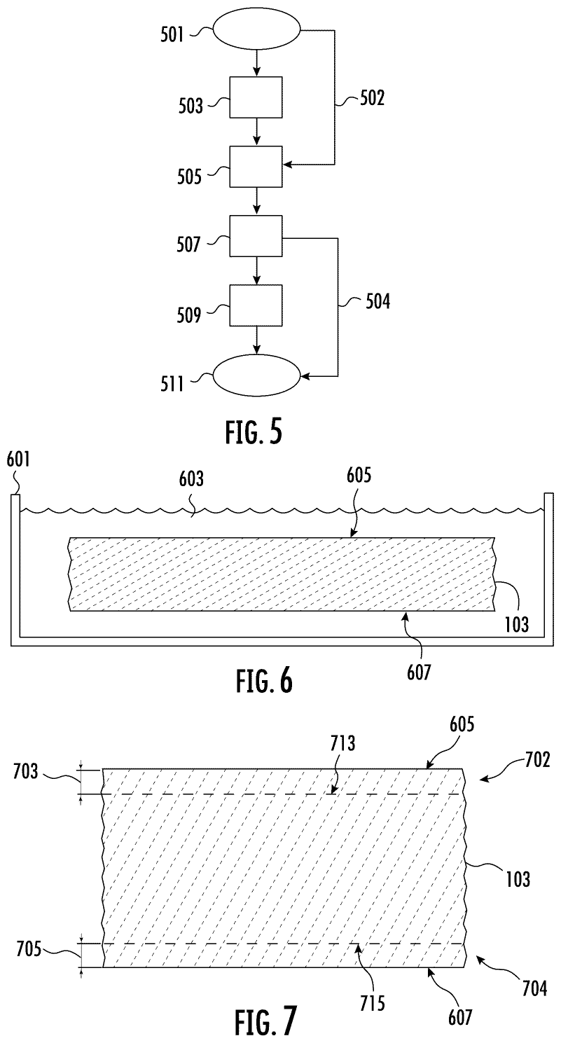

Aspects of methods of making the anti-sparkle substrate 101 illustrated in FIGS. 1-2, in accordance with aspects of the disclosure, will be discussed with reference to the flow chart in FIG. 5 and example method steps illustrated in FIGS. 6-9.

As shown in FIG. 5, methods of the disclosure can start at step 501 including providing a substrate 103. In aspects, the substrate 103 may be provided by purchase or otherwise obtaining a substrate or by forming the substrate. In aspects, the substrate 103 can comprise a glass-based material or a ceramic-based material. In further aspects, glass-based substrates can be provided by forming them with a variety of ribbon forming processes, for example, slot draw, down-draw, fusion down-draw, up-draw, press roll, redraw, or float. In further aspects, glass-based substrates comprising ceramic crystals can be provided by heating a glass-based substrate to crystallize one or more ceramic crystals. In aspects, the substrate 103 can be chemically strengthened (e.g., comprising a first compressive stress region and/or a second compressive stress region), although the substrate 103 can be chemically strengthened (or further chemically strengthened) in step 503.

After step 501, in aspects, as shown in FIG. 5, methods can proceed to step 503 comprising chemically strengthening the substrate 103. In aspects, as shown in FIG. 6, the substrate can comprise an existing first major surface 605 and an existing second major surface 607 opposite the existing first major surface 605. In further aspects, an existing thickness of the substrate 103 in step 503 (e.g., an average distance between the existing first major surface and the existing second major surface) can be within one or more of the ranges discussed above for the substrate thickness 109. In even further aspects, the existing thickness of the substrate 103 in step 503 can be greater than the substrate thickness 109 of the resulting anti-sparkle substrate 101 (e.g., as a result of abrading and etching the substrate in steps 505 and 507) by about 5 μm or more, about 9 μm or more, about 15 μm or more, about 18 μm or more, about 25 μm or more, about 40 μm or more, about 200 μm or less, about 100 μm or less, about 80 μm or less, about 60 μm or less, about 50 μm or less, about 30 μm or less, or about 20 μm or less. In even further aspects, the existing thickness of the substrate 103 in step 503 can be greater than the substrate thickness 109 of the resulting anti-sparkle substrate 101 by an amount in a range from about 5 μm to about 200 μm, from about 5 μm to about 100 μm, from about 9 μm to about 80 μm, from about 9 μm to about 60 μm, from about 15 μm to about 50 μm, from about 18 μm to about 30 μm, or any range or subrange therebetween.

In aspects, as shown in FIG. 6, chemically strengthening the substrate 103 in step 503 comprises chemically strengthening at least the existing first major surface 605. As shown in FIG. 6, step 503 can further comprise chemically strengthening the existing second major surface 607 in addition to the existing first major surface 605. In aspects, as shown, chemically strengthening the substrate 103 in step 503 can comprise contacting (e.g., immersing) at least the existing first major surface 605 with a molten salt solution 603 contained in a container 601. In further aspects, as shown, the entire substrate 103 can be immersed in the molten salt solution 603, although applying a paste to at least the first major surface and heating the substrate can be used to chemically strengthen the substrate in other aspects. In aspects, the molten salt solution 603 can comprise a source of sodium ions and/or a source of potassium ions. In further aspects, the source of potassium ions can be potassium nitrate and/or the source of sodium ions can be sodium nitrate. In aspects, a total amount of the source of sodium ions and the source of potassium ions, as a wt % of the molten salt solution, can be 50% or more, 70% or more, 80% or more, 90% or more, 95% or more, 97% or more, 98% or more, or 99% or more. In aspects, the molten salt solution can optionally include silicic acid (e.g., from 0.1 wt % to 5 wt %, from 0.2 wt % to 2 wt %, from 0.5 wt % to 1 wt %, or any range or subrange therebetween). In aspects, the molten salt solution can optionally include a source of other (i.e., other than sodium and potassium) alkali ions (e.g., lithium) of 10 wt % or less, 5 wt % or less, 2 wt % or less, 1 wt % or less, or 0.5 wt % or less.

In aspects, exposing at least the existing first major surface 605 to the molten salt solution 603 in step 503 can occur for 5 minutes or more, 10 minutes or more, 15 minutes or more, 30 minutes or more, 45 minutes or more, 1 hour or more, 1.5 hours or more, 2 hours or more, 8 hours or less, 4 hours or less, 3 hours or less, 2 hours or less, 1.5 hours or less, 1 hour or less, 0.75 hours or less, or 0.50 hours or less. In aspects, the exposing at least the existing first major surface 605 to the molten salt solution 603 in step 503 can occur for a period of time in a range from 5 minutes to 8 hours, from 10 minutes to 4 hours, from 30 minutes to 2 hours, from 45 minutes to 1.5 hours, or any range or subrange therebetween. In aspects, the exposing at least the existing first major surface 605 to the molten salt solution 603 in step 503 can occur for an hour or less, for example, in a range from 5 minutes to 1 hour, from 10 minutes to 0.75 hours, from 15 minutes to 0.5 hours, or any range or subrange therebetween. In aspects, the molten salt solution 603 can be maintained at (e.g., during the exposing in step 503) a temperature of 370° C. or more, 380° C. or more, 390° C. or more, 400° C. or more, 410° C. or more, 420° C. or more, 500° C. or less, 480° C. or less, 460° C. or less, 440° C. or less, 420° C. or less, or 400° C. or less. In aspects, the molten salt solution 603 can be maintained at (e.g., during the exposing in step 503) a temperature in a range from 370° C. to 500° C., from 370° C. to 480° C., from 380° C. to 460° C., from 380° C. to 440° C., from 390° C. to 420° C., from 390° C. to 400° C., or any range of subrange therebetween.

As shown in FIG. 17, the chemical strengthening can form at least an intermediate first compressive stress region 702 extending to an intermediate first depth of compression 703 from the existing first major surface 605. In aspects, as shown, the chemical strengthening can further form an intermediate second compressive stress region 704 extending to an intermediate second depth of compression 705 from the existing second major surface 607. As shown in FIG. 17, the intermediate first depth of compression 703 and/or the intermediate second depth of compression 705 extend from the corresponding major surface to a location (indicated by dashed line 713 and/or 715) that a stress profile switches from compressive to tensile (e.g., 0 MPa). An intermediate maximum first compressive stress of the intermediate first compressive stress region can be 25 MPa or more, about 50 MPa or more, 100 MegaPascals or more, about 300 MPa or more, about 500 MPa or more, about 700 MPa or more, about 1,500 MPa or less, about 1,200 MPa or less, about 1,000 MPa or less, or about 900 MPa or less. In further aspects, the intermediate maximum first compressive stress and/or the maximum second compressive stress can be in a range from about 25 MPa to about 1,500 MPa, from about 25 MPa to about 1,200 MPa, from about 50 MPa to about 1,200 MPa, from about 100 MPa to about 1,200 MPa, from about 300 MPa to about 1,000 MPa, from about 300 MPa to about 1,000 MPa, from about 500 MPa to about 900 MPa, from about 700 MPa to about 900 MPa, or any range or subrange therebetween.

In aspects, step 503 can comprise contacting at least the existing first major surface to a plurality of molten salt solutions (e.g., sequentially). In further aspects, a total time that the existing first major surface is in contact with a plurality of molten salt solutions can be within one or more of the corresponding ranges discussed above for step 503. In further aspects, the plurality of molten salt solutions can sequentially increase an amount of a source of potassium ions.

In aspects, although not shown, step 503 can further comprise heating the substrate 103 after the chemical strengthening. In further aspects, the substrate can be heated at a temperature greater than the temperature that the molten salt solution was maintained at. In further aspects, the substrate can be heated at a temperature of about 450° C. or more, about 480° C. or more, about 500° C. or more, about 600° C. or less, about 550° C. or less, about 520° C. or less, or about 500° C. or less. In further aspects, the substrate can be heated at a temperature in a range from about 450° C. to about 600° C., from about 480° C. to about 550° C., from about 500° C. to about 520° C. or any range or subrange therebetween. In aspects, the substrate can be heated for a period of time of 15 minutes or more, 30 minutes or more, 1 hour or less, 45 minutes or less, or 30 minutes or less, for example, in a range from 15 minutes to 1 hour, from 30 minutes to 45 minutes, or any range or subrange therebetween.

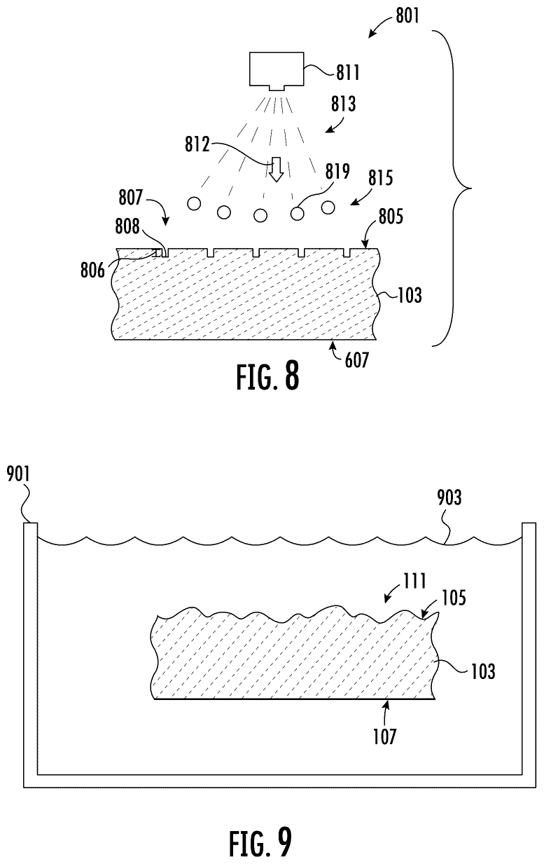

After step 501 or 503, as shown in FIG. 5, methods can proceed to step 505 comprising abrading the existing first major surface 605 (see FIG. 6) to form an intermediate first major surface 805 (see FIG. 8). In aspects, as shown in FIG. 8, the abrading the existing first major surface comprises impinging the existing first major surface with particles 815 propelled (as indicated by arrow 812) from an orifice (e.g., nozzle 811 of an abrading apparatus 801) to form the intermediate first major surface 805 with pits 808 formed by the abrading. In further aspects, as shown, the particles 815 propelled from the nozzle 811 can spread out (as indicated by spray 813), which may be able to abrade a predetermined portion of the existing first major surface, although the nozzle may be rotated or moved to abrade an entirety of a predetermined portion of the existing first major surface in other aspects. In further aspects, the particles 819 can be fed to the nozzle 811 as a slurry comprising, based on 100 wt % of the slurry, 10 wt % or more, 12 wt % or more, 15 wt % or more, 17 wt % or more, 20 wt % or more, 22 wt % or more, 25 wt % or more, 30 wt % or less, 27 wt % or less, 25 wt % or less, 22 wt % or less, 20 wt % or less, 17 wt % or less, or 15 wt % or less. In further aspects, the particles 819 can be fed to the nozzle 811 as a slurry comprising, based on 100 wt % of the slurry, in a range from 10 wt % to 30 wt %, from 12 wt % to 27 wt %, from 15 wt % to 25 wt %, from 17 wt % to 22 wt %, from 17 wt % to 20 wt %, or any range or subrange therebetween. In further aspects, a pressure used to propel (arrow 812) the particles 815 through the nozzle 811 can be about 200 kiloPascals (kPa) or more, about 225 kPa or more, about 250 kPa or more, about 275 kPa or more, about 300 kPa or more, about 325 kPa or more, about 350 kPa or more, about 375 kPa or more, about 400 kPa or more, about 425 kPa or more, about 450 kPa or more, about 550 kPa or less, about 525 kPa or less, about 500 kPa or less, about 475 kPa or less, about 450 kPa or less, about 425 kPa or less, about 400 kPa or less, about 375 kPa or less, about 350 kPa or less, about 325 kPa or less, or about 300 kPa or less. In further aspects, a pressure used to propel (arrow 812) the particles 815 through the nozzle 811 can be in a range from about 200 kPa to about 550 kPa, from about 200 kPa to about 525 kPa, from about 225 kPa to about 500 kPa, from about 225 kPa to about 475 kPa, from about 250 kPa to about 450 kPa, from about 250 kPa to about 425 kPa, from about 275 kPa to about 400 kPa, from about 275 kPa to about 375 kPa, from about 300 kPa to about 350 kPa, or any range or subrange therebetween.

In aspects, the particles 815 can comprise SiC, Al₂O₃, or combinations thereof. In aspects, a median particle size of a particle 819 of the particles 815 can be about 3 μm or more, about 4 μm or more, about 5 μm or more, about 6 μm or more, about 7 μm or more, about 8 μm or more, about 13 μm or less, about 12 μm or less, about 11 μm or less, about 10 μm or less, about 9 μm or less, about 8 μm or less, about 7 μm or less, about 6 μm or less, or about 5 μm or less. In aspects, the median particle size of a particle 819 of the particles 815 can be in a range from about 3 μm to about 13 μm, from about 3 μm to about 12 μm, from about 4 μm to about 11 μm, from about 4 μm to about 10 μm, from about 5 μm to about 9 μm, from about 5 μm to about 8 μm, from about 6 μm to about 7 μm, or any range or subrange therebetween. While a smaller median particle size of the particle 819 can produce smaller pits 808 (e.g., width of the pits and/or depth 806 of the pits), there is a physical and commercial limit to how small (and how uniform such) particles can be manufactured (and provided for step 505). In the absence of a chemically strengthened substrate (as produced by step 503), abrading followed by etching (step 507) produces textured substrates with high sparkle (e.g., 4% or more) and/or high haze (e.g., 40% or more), which is undesirable for use with high-resolution display devices. As indicated by the Examples here, chemically strengthening the substrate (step 503 or otherwise providing a chemically strengthened substrate) before abrading the substrate unexpectedly produces smaller pits, which can be etched to produce anti-sparkle substrates in accordance with aspects of the present disclosure with low sparkle and/or the other optical properties recited herein.

After step 505, as shown in FIG. 5, methods can proceed to step 507 comprising etching the intermediate first major surface to form a first major surface of the anti-sparkle substrate. In aspects, as shown in FIG. 9, step 507 can comprise contacting at least the intermediate first major surface (see FIG. 8) with an etchant 903 (e.g., contained in a container 901) to form the textured surface 111 of the first major surface 105. In further aspects, the intermediate first major surface can be immersed in the etchant 903 contained in the container 901 to form the textured surface 111 of the first major surface 105. In further aspects, as shown, step 507 can comprise immersing the entire substrate 103 in the etchant 903 contained in the container 901. At the end of step 507, regardless of if the existing second major surface is etched in step 507, the existing second major surface (or resulting surface) is referred to as the second major surface 107.

Etching the intermediate first major surface generates the textured surface 111 of the first major surface 105, for example, by the etchant isotropically etching the pits to form a smooth, textured surface. Since the pits 808 (see FIG. 8) can be irregular (e.g., spatial distribution, width, and/or depth 806), the resulting textured surface 111 can also be irregular, as discussed above. In aspects, a thickness of the substrate 103 removed from the intermediate first major surface 805 (see FIG. 8) during the etching in step 507 can be greater than or equal to the intermediate first depth of compression 703 (see FIG. 7), which can remove the entire intermediate first compressive stress region 702 to produce an anti-sparkle substrate with a first major surface 105 that is substantially unstrengthened. Alternatively, a thickness of the substrate 103 removed from the intermediate first major surface 805 (see FIG. 8) during the etching in step 507 can be less than the intermediate first depth of compression 703 (see FIG. 7) to produce a compressive stress region of resulting anti-glare substrate with a maximum first compressive stress that is non-zero and can be within one or more of the corresponding range discussed above (e.g., from 25 MPa to 1200 MPa) while still being less than the intermediate maximum first compressive stress. In aspects, equal amounts of material (e.g., thickness) can be removed from the intermediate first major surface 807 can the existing second major surface 607 (see FIG. 8) in step 505 such that a difference between the thickness of the substrate in step 501 and the substrate thickness 109 of the anti-sparkle substrate 101 can be within one or more of the corresponding ranges discussed above with reference to step 501. In aspects, a thickness removed from the intermediate first major surface 805 (see FIG. 8—without regard for any thickness removed from the existing second major surface 607) by the etching in step 507 can be about 5 μm or more, about 7 μm or more, 9 μm or more, about 12 μm or more, about 15 μm or more, about 18 μm or more, about 20 μm or more, about 22 μm or more, about 25 μm or more, about 100 μm or less, about 80 μm or less, about 60 μm or less, about 40 μm or less, about 30 μm or less, about 28 μm or less, about 25 μm or less, about 23 μm or less, or about 20 μm or less. In aspects, a thickness removed from the intermediate first major surface 805 (see FIG. 8—without regard for any thickness removed from the existing second major surface 607) by the etching in step 507 can be in a range from about 5 μm to about 100 μm, from about 5 μm to about 80 μm, from about 7 μm to about 60 μm, from about 9 μm to about 40 μm, from about 12 μm to about 30 μm, from about 15 μm to about 28 μm, from about 18 μm to about 25 μm, from about 20 μm to about 23 μm, or any range or subrange therebetween.

In aspects, the etchant 903 can be an acidic solution. In further aspects, the acidic solution can comprise a mineral acid. In further aspects, the acidic solution can comprise hydrofluoric acid. In even further aspects, a concentration of hydrofluoric acid in the acidic solution, based on 100 wt % of the acidic solution, can be 1 wt % or more, 2 wt % or more, 3 wt % or more, 5 wt % or more, 7 wt % or more, 10 wt % or more, 20 wt % or less, 17 wt % or less, 15 wt % or less, 12 wt % or less, 10 wt % or less, or 8 wt % or less. In even further aspects a concentration of hydrofluoric acid in the acidic solution, based on 100 wt % of the acidic solution, can be in a range from 1 wt % to 20 wt %, from 2 wt % to 18 wt %, from 3 wt % to 15 wt %, from 5 wt % to 12 wt %, from 7 wt % to 10 wt %, or any range or subrange therebetween. In further aspects, in step 507, the acidic solution can be maintained at a temperature of 20° C. or more, 23° C. or more, 25° C. or more, 30° C. or more, 35° C. or more, 45° C. or less, 40° C. or less, 36° C. or less, 30° C. or less, 27° C. or less, or 25° C. or less. In further aspects, in step 507, the acidic solution can be maintained at a temperature in a range from 20° C. to 45° C., 20° C. to 40° C., from 23° C. to 36° C., from 23° C. to 30° C., from 25° C. to 30° C., or any range or subrange therebetween. In further aspects, the first intermediate surface can be in contact with the acidic solution in step 507 for a period of time of 2 minutes or more, 5 minutes or more, 10 minutes or more, 15 minutes or more, 20 minutes or more, 30 minutes or more, 45 minutes or more, 60 minutes or more, 2 hours or less, 1.5 hours or less, 1.25 hours or less, 1 hour or less, 0.75 hours or less, 0.5 hours or less, or 0.25 hours or less. In further aspects, the first intermediate surface can be in contact with the acidic solution in step 507 for a period of time in a range from 2 minutes to 2 hours, from 5 minutes to 1.5 hours, from 10 minutes to 1.25 hours, from 15 minutes to 1 hour, from 20 minutes to 0.75 hours, from 20 minutes to 0.5 hours, or any range or subrange therebetween.

Alternatively, in aspects, the etchant 903 can be an alkaline solution comprising a hydroxide-containing compound. In further aspects, the hydroxide-containing compound can be an alkali metal hydroxide (e.g., NaOH, KOH) or ammonia hydroxide. In further aspects, a concentration of the hydroxide-containing compound, based on 100 wt % of the etchant, can be 10 wt % or more, 15 wt % or more, 20 wt % or more, 25 wt % or more, 30 wt % or more, 35 wt % or more, 40 wt % or more, 45 wt % or more, 50 wt % or more, 70 wt % or less, 65 wt % or less, 60 wt % or less, 55 wt % or less, 50 wt % or less, 45 wt % or less, 40 wt % or less, 35 wt % or less, or 30 wt % or less. In further aspects, a concentration of the hydroxide-containing compound, based on 100 wt % of the etchant, can be in a range from 10 wt % to 70 wt %, from 10 wt % to 65 wt %, from 15 wt % to 60 wt %, from 15 wt % to 55 wt %, from 20 wt % to 50 wt %, from 25 wt % to 45 wt %, from 30 wt % to 40 wt %, or any range or subrange therebetween. In further aspects, in step 507, the alkaline solution can be maintained at a temperature of 95° C. or more, 100° C. or more, 105° C. or more, 110° C. or more, 115° C. or more, 120° C. or more, 125° C. or more, 130° C. or more, 140° C. or more, 150° C. or more, 165° C. or less, 160° C. or less, 155° C. or less, 150° C. or less, 145° C. or less, 140° C. or less, 135° C. or less, 130° C. or less, 120° C. or less, or 110° C. or less. In further aspects, in step 507, the alkaline solution can be maintained at a temperature in a range from 95° C. to 155° C., from 100° C. to 150° C., from 105° C. to 145° C., from 110° C. to 140° C., from 115° C. to 135° C., from 120° C. to 130° C., or any range or subrange therebetween. In further aspects, the first intermediate surface can be in contact with the alkaline solution in step 507 for a period of time of can be 10 minutes or more, 20 minutes or more, 30 minutes or more, 45 minutes or more, 60 minutes or more, 90 minutes or more, 120 minutes or more, 4 hours or less, 3 hours or less, 2.5 hours or less, 2 hours or less, 1.5 hours or less, or 1 hour or less. In further aspects, the first intermediate surface can be in contact with the alkaline solution in step 507 for a period of time in a range from 10 minutes to 4 hours, from 20 minutes to 3 hours, from 30 minutes to 2.5 hours, from 45 minutes to 2 hours, from 60 minutes to 1.5 hours, or any range or subrange therebetween.

After step 507, methods can proceed to step 509 comprising assembling a display device (e.g., the consumer electronic device in FIGS. 3-4) comprising the anti-sparkle substrate 101. For example, the second major surface 107 of the anti-sparkle substrate 101 can be disposed over (and/or face) a pixelated display of the display device. Also, in aspects, an optical stack can be positioned between the second major surface 107 of the anti-sparkle substrate 101 and the pixelated display. In aspects, as described above, the anti-sparkle substrate 101 can be used in conjunction with a plurality of light-emitting diodes (e.g., LED, OLED), for example, in a pixelated display, as part of a display device and/or a consumer electronic device. After step 507 or 511, methods can be complete upon reaching step 511.

In aspects, methods of making an anti-sparkle substrate 101 in accordance with aspects of the disclosure can proceed along steps 501, 503, 505, 507, 509, and 511 of the flow chart in FIG. 5 sequentially, as discussed above. In aspects, arrow 502 can be followed from step 501 to step 505, for example, when the substrate 103 is chemically strengthened (e.g., intermediate first compressive stress region 702 extending to the intermediate first depth of compression 703) by the end of step 501. In aspects, arrow 504 can be followed from step 507 to step 511, for example, if methods are complete at the end of step 507. Any of the above options may be combined to make a color converter sheet in accordance with aspects of the disclosure.

### Examples

Various aspects will be further clarified by the following examples. Comparative Examples AA-CC and Examples 1-6 used a glass-based substrate (Composition A comprising approximately 64.5 mol % SiO₂, 15.9 mol % Al₂O₃, 6.3 mol % Li₂O, 10.9 mol % Na₂O, 1.2 mol % ZnO, and 1.1 mol % P₂O₅) with a thickness of 0.5 mm. Comparative Examples DD-FF and Examples 7-12 used a glass-based substrate (Composition B comprising approximately 68.6 mol % SiO₂, 12.7 mol % Al₂O₃, 0 mol % Li₂O, 13.6 mol % Na₂O, 3.7 mol % B₂O₃, and 2.3 mol % MgO) with a thickness of 1.0 mm.

Comparative Examples AA-FF were not chemically strengthened (i.e., the existing first major surface was unstrengthened) before the abrading. Examples 4-6 were chemically strengthened for 15 minutes in a molten salt bath comprising 99.5 wt % KNO₃ and 0.5 wt % LiNO₃ maintained at 380° C. Examples 1-3 were chemically strengthened as for Examples 4-6 and then heated at 500° C. for 30 minutes to reduce the maximum compressive stress from 1026 MPa to 122 MPa. Examples 10-12 were chemically strengthened for 6 hours in a molten salt bath comprising 100 wt % KNO₃ with 0.5 wt % silicic acid added by superaddition that is maintained at 500° C. Examples 7-9 were chemically strengthened as for Examples 10-12 and then further (e.g., reverse) ion-exchanged for 30 minutes in a molten salt bath comprising 50 wt % NaNO₃ and 50 wt % KNO₃ with 0.5 wt % silicic acid added by superaddition that is maintained at 520° C. to reduce the compressive stress from 587 MPa to 164 MPa. It is to be understood that the reduced compressive stress of Examples 1-3 and 7-9 (relative to Examples 4-6 and 10-12) can be obtained by modifying the single molten salt solution (instead of additional heat treatment or reverse ion-exchange).

The intermediate first major surface of Comparative Examples AA-FF and Examples 1-12 were abraded using SiC particles with a median particle size of 5 μm comprising 20 wt % of a slurry fed to a spray nozzle that propelled the SiC particles with a pressure of about 350 kPa. Then, Comparative Examples AA-FF and Examples 1-12 were etched in an alkaline solution comprising 50 wt % NaOH maintained at 120° C., where the etching time was adjusted to achieve the “etching thickness” removed from the first major surface (i.e., not including thickness removed from the second major surface) stated in Table 1 (from 10 μm to 40 μm).

TABLE 1
Processing and Surface Properties of Comparative
Examples AA-FF and Examples 1-12

| | Etching | Depth of | | | | | |
|---|---|---|---|---|---|---|---|
| | Thick- | Compres- | | | | | |
| | ness | sion | CS | Ra | Sq | Rsm | |
| | (μm) | (μm) | (MPa) | (μm) | (μm) | (μm) | Sdq |
| Comp. Ex. | 10 | 0 | 0 | 0.15 | 0.21 | 9.68 | 0.26 |
| AA | | | | | | | |
| Comp. Ex. | 20 | 0 | 0 | 0.14 | 0.20 | 14.31 | 0.14 |
| BB | | | | | | | |
| Comp. Ex. | 40 | 0 | 0 | 0.12 | 0.18 | 18.62 | 0.08 |
| CC | | | | | | | |
| Example 1 | 10 | 16 | 122 | 0.13 | 0.18 | 9.72 | 0.22 |
| Example 2 | 20 | 16 | 122 | 0.13 | 0.18 | 13.34 | 0.13 |
| Example 3 | 40 | 16 | 122 | 0.11 | 0.17 | 17.97 | 0.08 |
| Example 4 | 10 | 4 | 1026 | 0.09 | 0.12 | 10.22 | 0.16 |
| Example 5 | 20 | 4 | 1026 | 0.09 | 0.12 | 13.17 | 0.09 |
| Example 6 | 40 | 4 | 1026 | 0.08 | 0.12 | 13.62 | 0.06 |
| Comp. Ex. | 10 | 0 | 0 | 0.15 | 0.21 | 9.47 | 0.26 |
| DD | | | | | | | |
| Comp. Ex. | 20 | 0 | 0 | 0.13 | 0.19 | 14.27 | 0.13 |
| EE | | | | | | | |
| Comp. Ex. | 40 | 0 | 0 | 0.11 | 0.17 | 18.79 | 0.07 |
| FF | | | | | | | |
| Example 7 | 10 | 89 | 164 | 0.12 | 0.16 | 10.15 | 0.19 |
| Example 8 | 20 | 89 | 164 | 0.09 | 0.12 | 14.57 | 0.08 |
| Example 9 | 40 | 89 | 164 | 0.06 | 0.10 | 20.02 | 0.04 |
| Example 10 | 10 | 99 | 587 | 0.06 | 0.09 | 11.07 | 0.08 |
| Example 11 | 20 | 99 | 587 | 0.04 | 0.06 | 15.76 | 0.04 |
| Example 12 | 40 | 99 | 587 | 0.04 | 0.06 | 15.76 | 0.04 |

Table 1 presents the processing details and surface properties of Comparative Examples AA-FF and Examples 1-12 while Table 2 presents the optical properties of these samples. As shown in Table 1, Examples 1 and 4 had a greater thickness removed by etching than the depth of compression provided by the chemical strengthening. Consequently, Examples 1 and 4 were substantially unstrengthened by the end of the processing even though Examples 1 and 4 were chemically strengthened before the abrading. On the other hand, Examples 2-3 and 5-12 are expected to have noticeable compressive stress region regions and maximum compressive stress values in the final anti-sparkle substrate. In contrast, Comparative Examples AA-FF were unstrengthened before the abrading and remained as unstrengthened substrates after the etching.

As shown in Table 1, the surface roughness Ra, height Rq, and gradient Sdq generally decrease (although the resolution of the measurement may result in the same value being reported) as the thickness removed by the etching increases for the same chemical strengthening treatment (demarcated by the thicker lines), which is expected as the etching smoothed out the pits formed by the abrading. By similar reasoning, it is expected that widths of the features Rsm increase as the thickness removed by the etching increases. Between the different chemical strengthening treatments, the greater the compressive stress (CS) reported in Table 1 results in lower roughness Ra and height Rq (e.g., comparing Comparative Example AA to Example 1 and Example 4). This demonstrates that increasing compressive stress from the chemical strengthening decreases the size of the pits formed by the abrading.

Table 2 presents the optical properties of Comparative Examples AA-FF and Examples 1-12. Examples 1-12 and Comparative Examples AA-FF have transmittance (T) from 92% to 94%. For the same amount of thickness removed by the etching, increasing the compressive stress generally increases the transmittance. Likewise, for the same amount of thickness removed by the etching, increasing the compressive stress decreases the haze. Both of these trends can be attributed to the reduced size of pits formed by the abrading from increasing compressive stress from the chemical strengthening. Comparative Examples AA-FF have haze greater than 10% while Examples 6, 8, and 11-12 have less than 10% haze.

TABLE 2
Optical Properties of Comparative Examples AA-FF and Examples 1-12

| | | Haze | Gloss | DOI | Sparkle |
|---|---|---|---|---|---|
| | T (%) | (%) | (%) | (%) | (%) |
| Comp. Ex. AA | 92.4 | 40 | 21 | 90.1 | 3.3 |
| Comp. Ex. BB | 92.8 | 25 | 31 | 87.2 | 3.9 |
| Comp. Ex. CC | 93.0 | 14 | 46 | 85.1 | 4.7 |
| Example 1 | 92.5 | 35 | 26 | 93.7 | 3.2 |
| Example 2 | 92.9 | 23 | 34 | 91.3 | 3.8 |
| Example 3 | 93.0 | 13 | 50 | 88.9 | 4.5 |
| Example 4 | 92.8 | 19 | 57 | 97.6 | 2.9 |
| Example 5 | 93.0 | 14 | 58 | 95.7 | 3.4 |
| Example 6 | 93.1 | 8.7 | 67 | 93.8 | 3.8 |
| Comp. Ex. DD | 92.6 | 41 | 19 | 88.9 | 3.2 |
| Comp. Ex. EE | 93.1 | 23 | 32 | 87.9 | 4.0 |
| Comp. Ex. FF | 93.2 | 12 | 50 | 86.0 | 4.7 |
| Example 7 | 92.7 | 29 | 31 | 95.3 | 3.1 |
| Example 8 | 93.1 | 12 | 60 | 95.1 | 3.6 |
| Example 9 | 93.2 | 3.5 | 101 | 95.5 | 3.8 |
| Example 10 | 93.0 | 11 | 79 | 97.8 | 2.2 |
| Example 11 | 93.2 | 3.4 | 116 | 98.0 | 2.0 |
| Example 12 | 93.2 | 0.9 | 128 | 98.3 | 1.5 |

As shown in Table 2, Comparative Examples BB-CC and EE-FF have a sparkle greater than 3.9% while Examples 1-2, 4-5, and 7-12 have a sparkle of 3.8% or less. Further, Examples 4, 7, and 10-12 have a sparkle from about 1.5% to 3.1%. Comparative Examples AA-FF have gloss values of 50% or less while Examples 4-6 and 8-12 have gloss values of 50% or more (e.g., Examples 9-12 have a haze of 75% or more). On the other hand, Examples-2 and 7 have a gloss of 50% or less (e.g., from about 20% to about 50%). Comparative Examples AA-FF have DOI values from about 85% to about 90% while Examples 1-2 and 4-12 have DOI values of 91% or more and Examples 4-6 and 7-12 have DOI values of about 93% or more (e.g., about 94% or more).

As shown in Table 2, examples with more compressive stress have about the same or lower sparkle than those with lower compressive stress (e.g., compare Comparative Example BB to Examples 2 and 4; compare Comparative Example CC to Example 3 and Example 6; compare Comparative Example DD to Examples 7 and 10; compare Comparative Example EE to Examples 8 and 11; and compare Comparative Example FF to Examples 9 and 12). Similarly, increasing compressive stress is associated with decreasing haze, increasing DOI, and increasing gloss.

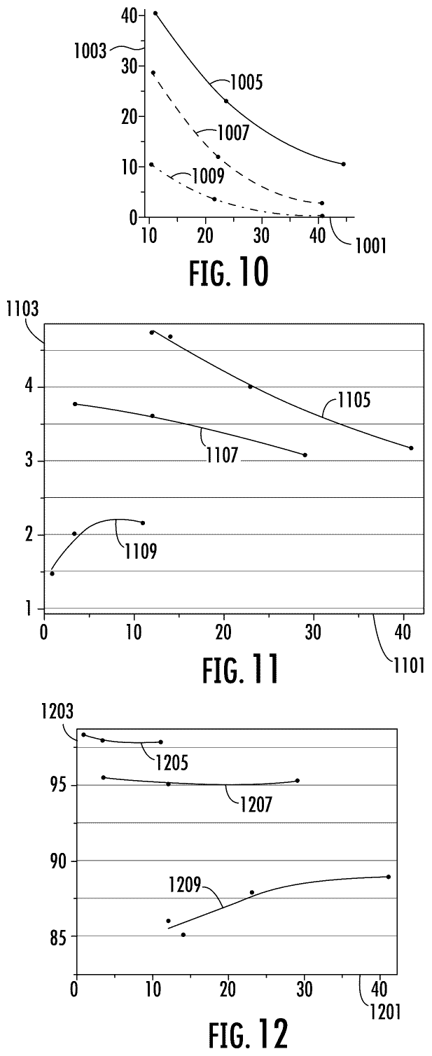

FIG. 10 schematically illustrates haze as a function of thickness removed by etching. In FIG. 10, the horizontal axis 1001 (e.g., x-axis) corresponds to the thickness removed in micrometers (μm), and the vertical axis 1003 (e.g., y-axis) corresponds to haze (%). Curve 1005 corresponds to Comparative Examples CC-FF, curve 1007 corresponds to Examples 7-9, and curve 1009 corresponds to Examples 10-12. As shown, the haze decreases as the compressive stress increases (going from curve 1005 to curve 1007 and curve 1009).

FIG. 12 schematically illustrates DOI as a function of haze. In FIG. 12, the horizontal axis 1201 (e.g., x-axis) corresponds to the haze (%), and the vertical axis 1203 (e.g., y-axis) corresponds to DOI (%). Curve 1209 corresponds to Comparative Examples CC-FF, curve 1207 corresponds to Examples 7-9, and curve 1205 corresponds to Examples 10-12. As shown, increasing compressive stress is associated with increasing DOI. Also, increasing the depth removed by etching is associated with increasing DOI and decreasing haze. Further, FIG. 12 indicates that DOI and haze are negatively correlated for these examples.

FIG. 11 schematically illustrates sparkle as a function of haze. In FIG. 11, the horizontal axis 1101 (e.g., x-axis) corresponds to the haze (%), and the vertical axis 1103 (e.g., y-axis) corresponds to sparkle (%). Curve 1105 corresponds to Comparative Examples CC-FF, curve 1107 corresponds to Examples 7-9, and curve 1109 corresponds to Examples 10-12. As shown, increasing compressive stress is associated with decreasing sparkle. Also, increasing the depth removed by etching is generally associated with increasing sparkle and decreasing haze. For the highest compressive stress (curve 1309), the lowest sparkle was achieved for Example 12. Although FIGS. 10 and 12 show results for Comparative Example DD-FF and Examples 7-12, similar trends were observed for Comparative Examples AA-CC and Examples 1-6 as well.

The above observations can be combined to provide an anti-sparkle substrate and display devices including anti-sparkle substrates that can reduce a sparkle thereof by providing a textured surface as part of a first major surface of the anti-sparkle substrate. Reducing a sparkle through the anti-sparkle substrate of the present disclosure can increase a uniformity of light emitted from the display device, as perceived by a viewer of a display device, and/or increase an aesthetic appeal of the resulting display device by reducing the perceived graininess associated with sparkle. As demonstrated by the Examples, methods of present disclosure can provide an anti-sparkle substrate exhibiting a sparkle of 3.8% or less (e.g., 3.5% or less or 3.1% or less), which is not achieved by the Comparative Examples. As demonstrated by the Examples, methods of present disclosure can provide an anti-sparkle substrate exhibiting a gloss of 50% or more and/or an DOI of 91% or more (e.g., 93% or more), which is not achieved by the Comparative Examples.

Without wishing to be bound by theory, it is believed that the characteristics of the textured surface of the first major surface (e.g., surface roughness Ra, height Rq, width Rsm, gradient Sdq) generated by the methods of present disclosure enable the above-reciting combinations of optical properties to be achieved simultaneously. While a select set of combinations of ranges for optical properties of the anti-sparkle substrate are set forth in this paragraph, it is to be understood that other combinations of ranges of these optical properties and/or combinations involving other optical properties reciting in the present disclosure are also possible in other aspects. Providing the anti-sparkle substrate as a glass-based substrate and/or ceramic-based substrate can increase a damage resistance of the display device.

The textured surface of the anti-sparkle substrate can be formed by abrading and then etching a first major surface that has already been chemically strengthened. As discussed herein for methods of making the anti-sparkle substrate (e.g., textured surface), the present disclosure can provide smaller peaks and/or valleys that would otherwise be obtainable by abrading the first major surface, and the smaller peaks and/or valleys enable a lower sparkle and other optical properties recited herein. While a smaller median particle size of the particle can produce smaller pits (e.g., width of the pits and/or depth of the pits), there is a physical and commercial limit to how small (and how uniform such) particles can be manufactured. In the absence of a chemically strengthened substrate, abrading followed by etching produces textured substrates with high sparkle (e.g., 4% or more) and/or high haze (e.g., 40% or more), which is undesirable for use with high-resolution display devices. As indicated by the Examples here, chemically strengthening the substrate before abrading the substrate unexpectedly produces smaller pits, which can be etched to produce anti-sparkle substrates in accordance with aspects of the present disclosure with low sparkle and/or the other optical properties recited herein.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed:

1. A method of forming an anti-sparkle substrate:
chemically strengthening an existing first major surface;
abrading the existing first major surface to form an intermediate first major surface; and
etching the intermediate first major surface to form a first major surface of the anti-sparkle substrate,
wherein the anti-sparkle substrate exhibits a haze from 3% to 40% and a sparkle from 1% to 4%.

2. The method of claim 1, wherein the chemically strengthening comprises exposing the existing first major surface to a molten salt solution maintained a first temperature from 370° C. to 500° C. for a first period of time from 5 minutes to 8 hours, and the chemically strengthening forms an intermediate compressive stress region extending from the existing first major surface with an intermediate maximum compressive stress from 25 MegaPascals to 1500 MegaPascals.

3. The method of claim 1, wherein the first major surface of the anti-sparkle substrate is substantially unstrengthened.

4. The method of claim 1, wherein the abrading comprises impinging the existing first major surface with particles comprising a median particle size of 3 micrometers to 15 micrometers.

5. The method of claim 4, wherein the particles are propelled with a pressure from 200 kiloPascals to 550 kiloPascals.

6. The method of claim 4, wherein the particles comprise SiC, Al₂O₃, or combinations thereof.

7. The method of claim 4, wherein the etching removes a thickness of from 5 micrometers to 100 micrometers from the intermediate first major surface.

8. The method of claim 7, wherein the etching removes the thickness of from 9 micrometers to 40 micrometers from the intermediate first major surface.

9. The method of claim 1, wherein the etching comprises contacting the intermediate first major surface with an acidic solution maintained at a temperature from 20° C. to 45° C. for from 2 minutes to 2 hours.

10. The method of claim 1, wherein the etching comprises contacting the intermediate first major surface with an alkaline solution maintained at a temperature from 95° C. to 165° C. for from 10 minutes to 4 hours.

11. The method of claim 1, wherein the sparkle is from 2.7% to 4%, and the anti-sparkle substrate exhibits a light diffusion of 8% or more.

12. The method of claim 1, wherein the sparkle is from 1% to 2%, and the anti-sparkle substrate exhibits a light diffusion of 5% or less.

13. The method of claim 1, wherein the anti-sparkle substrate exhibits a transmittance of 92% or more, a gloss from 55% to 150%, and a distinctness of image from 75.1% to 100%.

14. The method of claim 1, wherein a surface roughness Ra of the first major surface is from 0.03 micrometers to 0.09 micrometers.

15. The method of claim 1, wherein a root mean square height Sq of the first major surface is from 0.05 micrometers to 0.17 micrometers.

16. An anti-sparkle substrate comprising:
a first major surface comprising a textured surface, a surface roughness Ra of the first major surface is from 0.03 micrometers to 0.09 micrometers,
wherein the anti-sparkle substrate is a glass-based substrate or a ceramic-based substrate, and the anti-sparkle substrate exhibits a haze from 3% to 40% and a sparkle from 1% to 4%.

17. The anti-sparkle substrate of claim 16, wherein the anti-sparkle substrate comprises a compressive stress region extending from the first major surface comprising a maximum compressive stress from 25 MegaPascals to 1200 MegaPascals.

18. The anti-sparkle substrate of claim 16, wherein the first major surface of the anti-sparkle substrate is substantially unstrengthened.

19. The anti-sparkle substrate of claim 16, wherein the sparkle is from 2.7% to 4%, and the anti-sparkle substrate exhibits a light diffusion of 8% or more.

20. The anti-sparkle substrate of claim 16, wherein the sparkle is from 1% to 2%, and the anti-sparkle substrate exhibits a light diffusion of 5% or less.
